(19) United States
(12) Patent Application Publication
(10) Pub. No.: US 2010/0011672 A1
(43) Pub. Date: Jan. 21, 2010

(54) COATED ABRASIVE ARTICLE AND METHOD OF MAKING AND USING THE SAME

(76) Inventors: Don H. Kincaid, Hudson, WI (US); Ernest L. Thurber, Somerset, WI (US); Steven J. Keipert, Somerset, WI (US)

Correspondence Address: 3M INNOVATIVE PROPERTIES COMPANY, PO BOX 33427, ST. PAUL, MN, 55133-3427, US

(21) Appl. No.: 12/173,923

(22) Filed: Jul. 16, 2008

(51) Int. Cl. C08J 5/14; B24B 1/00

(52) U.S. Cl. 51/295; 51/298; 451/56

(57) ABSTRACT

A coated abrasive article comprises a fabric backing having a presize layer thereon, and an abrasive layer secured to and contacting the presize layer. The abrasive layer comprises a make layer and abrasive particles. The presize layer comprises, based on a total weight of components a) through f), a reaction product of components comprising: a) from 60 to 90 percent by weight of epoxy resin preparable by reaction of epichlorohydrin with bisphenol A; b) from 5 to 25 percent by weight of polyfunctional (meth)acrylate; c) from 10 percent by weight of aromatic acid-functional free-radically polymerizable material having an acid number up to 300; d) from 5 to 15 percent by weight of dicyandiamide; e) an effective amount of photoinitiator; and f) optionally, an effective amount of epoxy cure catalyst. Methods of making and using the same are also disclosed.

### TECHNICAL FIELD

The present disclosure relates generally to the abrasive arts, and more particularly to coated abrasive articles and methods of making and using them.

### BACKGROUND

In general, coated abrasive articles have an abrasive layer secured to a backing. The abrasive layer comprises abrasive particles and a binder that secures the abrasive particles to the backing.

One type of coated abrasive article has an abrasive layer comprised of a make layer and abrasive particles. In making such a coated abrasive article, a make layer precursor comprising a curable make resin is applied to a major surface of the backing. Abrasive particles are then at least partially embedded into the curable make resin (e.g., via electrostatic coating), and the curable make resin is at least partially cured (i.e., crosslinked) to adhere the abrasive particles to the backing. Commonly, a size layer precursor comprising a curable size resin is then applied over the at least partially cured curable make resin and abrasive particles, followed by curing of the curable size resin precursor, and optionally, further curing of the curable make resin.

Some coated abrasive articles additionally have a supersize layer covering the size layer. The supersize layer typically includes grinding aids and/or anti-loading materials.

Some coated abrasive articles have one or more backing treatments such as a backsize layer (i.e., a coating on the major surface of the backing opposite the major surface having the abrasive layer), a presize layer, a tie layer (i.e., a coating between the abrasive layer and the major surface to which the abrasive layer is secured), a saturant, a subsize treatment, or a combination thereof A subsize is similar to a saturant except that it is applied to a previously treated backing.

Phenolic resins have been used for years in abrasive articles such as, for example, high performance resin bond products (e.g., coarse grit coated abrasive articles). Phenolic resins typically exhibit strong adhesion and cohesive strength at a relatively low cost, but are prone to viscosity reduction during curing, for example, in a festoon oven curing processes that can be detrimental to the finished abrasive product. For example, if a phenolic resin is included in a make layer precursor (also known in the art as a “make coat”), this viscosity reduction during curing can result in some loss of mineral orientation resulting in reduced abrasive performance. In the case of phenolic resin fabric backing treatments, it is common for the phenolic resin coating to form openings during drying that require repeated treatment to achieve a properly sealed backing. This second step adds time and expense to the manufacturing process.

### SUMMARY

In one aspect, the present disclosure provides a coated abrasive article comprising a fabric backing having a presize layer thereon, and an abrasive layer secured to and contacting the presize layer; wherein the abrasive layer comprises a make layer and abrasive particles; and wherein the presize layer comprises, based on a total weight of components a) through f), a reaction product of components comprising:
a) from 60 to 90 percent by weight of epoxy resin preparable by reaction of epichlorohydrin with bisphenol A;
b) from 5 to 25 percent by weight of polyfunctional (meth)acrylate;
c) from 0.1 to 10 percent by weight of aromatic acid-functional free-radically polymerizable material having an acid number up to 300;
d) from 5 to 15 percent by weight of dicyandiamide;
e) an effective amount of photoinitiator; and
f) optionally, an effective amount of epoxy cure catalyst.

In some embodiments, the coated abrasive article further comprises a size layer overlaying the make layer and abrasive particles.

In some embodiments, the make layer comprises a phenolic resin.

In another aspect, the present disclosure provides a method of abrading a workpiece comprising:
providing a coated abrasive article according to the present disclosure;
frictionally contacting the abrasive layer with surface of the workpiece; and
moving at least one of the coated abrasive article and the workpiece relative to the other to abrade at least a portion of the surface.

In yet another aspect, the present disclosure provides a method of making an abrasive article comprising:

applying a presize layer precursor to a fabric backing, wherein based on a total weight of components a) through f), the presize layer precursor comprises components:
a) from 60 to 90 percent by weight of epoxy resin preparable by reaction of epichlorohydrin with bisphenol A;
b) from 5 to 25 percent by weight of polyfunctional (meth)acrylate;
c) from 0.1 to 10 percent by weight of acid-functional free-radically polymerizable material having an acid number up to 300;
d) from 5 to 15 percent by weight of dicyandiamide;
e) an effective amount of photoinitiator; and
f) optionally, an effective amount of epoxy cure catalyst;

at least partially curing the presize layer precursor to provide a presize layer secured to the fabric backing, wherein the presize layer substantially seals the fabric backing; and

disposing a make layer precursor on the presize layer;

embedding abrasive particles in the make layer precursor; and

at least partially curing the make layer precursor.

In some embodiments, the method further comprises disposing a size layer precursor on the at least partially cured make layer precursor and abrasive particles, and at least partially curing the size layer precursor.

In some embodiments, the components comprise: a) from 60 to 80 percent by weight of epoxy resin preparable by reaction of epichlorohydrin with at least one of bisphenol A; b) from 5 to 15 percent by weight of polyfunctional (meth)acrylate; c) from 1 to 5 percent by weight of acid-functional free-radically polymerizable material having an acid number up to 300; d) from 5 to 10 percent by weight of dicyandiamide; e) an effective amount of photoinitiator; and f) optionally, an effective amount of epoxy cure catalyst.

In some embodiments, the components comprise: a) from 75 to 80 percent by weight of epoxy resin preparable by reaction of epichlorohydrin with bisphenol A; b) from 10 to 15 percent by weight of polyfunctional (meth)acrylate; c) from 1 to 4 percent by weight of acid-functional free-radically polymerizable material having an acid number up to 300; d) from 5 to 10 percent by weight of dicyandiamide; e) an effective amount of photoinitiator; and f) optionally, an effective amount of epoxy cure catalyst.

Advantageously, coated abrasive articles including presize layers according to the present disclosure provide satisfactory levels of stripback adhesion and may effectively seal the fabric backing in a single coating and curing procedure. Moreover, presize layer precursors mitigate disadvantages encountered with widely used phenolic binder resins. For example, presize layer precursors according to the present disclosure are not prone to viscosity reduction during festoon oven curing.

As used herein:

“acid number” refers to the theoretical amount in milligrams of potassium hydroxide (i.e., KOH) necessary to neutralize the acid content of one gram of the material being referred to;

the verb “B-stage” means to convert to an intermediate stage of curing that will not spontaneously flow due to gravity, but will yield to applied pressure;

“(meth)acryl” includes acryl, methacryl, or both;

“polyepoxide” means a monomer, oligomer, or polymer having at least two epoxy groups; and

“polyfunctional poly(meth)acrylate” means an (meth)acrylate monomer, oligomer, or polymer having at least two (meth)acrylate groups.

### BRIEF DESCRIPTION OF THE DRAWING

FIG. 1 is a cross-sectional side view of an exemplary coated abrasive article according to the present disclosure.

### DETAILED DESCRIPTION

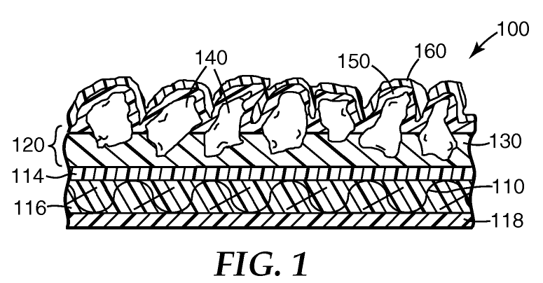

Referring now to FIG. 1, exemplary coated abrasive article 100 comprises fabric backing 110. Fabric backing 110 has presize layer 114 and optional backsize layer 118 thereon. In the case that fabric backing 110 is sufficiently porous, optional backsize layer 118 and presize layer 114 penetrate into the backing, and may even contact each other at points within the porous interior of the backing in some cases. Presize layer 114 is derived from a presize layer precursor. Overlaying presize layer 114 is abrasive layer 120. As shown, abrasive layer 120 comprises make layer 130 in which are embedded abrasive particles 140 and optional size layer 150 which overlays make layer 130 and abrasive particles 140. Make layer 130 and optional size layer 150 secure abrasive particles 140 to presize layer 114, and hence fabric backing 110. Make layer 130 and optional size layer 150 are derived from corresponding precursors. Optional supersize layer 160 overlays optional size layer 150.

Suitable fabric backings include, for example, those known in the art for making coated abrasive articles. Typically, the fabric backing has two opposed major surfaces. The thickness of the backing generally ranges from about 0.02 to about 5 millimeters, desirably from about 0.05 to about 2.5 millimeters, and more desirably from about 0.1 to about 0.4 millimeter, although thicknesses outside of these ranges may also be useful. Exemplary fabric backings include nonwoven fabrics (e.g., including needletacked, meltspun, spunbonded, hydroentangled, or meltblown nonwoven fabrics), knitted, stitchbonded, and woven fabrics; scrims; combinations of two or more of these materials; and treated versions thereof.

The fabric backing can be made from any known fibers, whether natural, synthetic or a blend of natural and synthetic fibers. Examples of useful fiber materials include fibers or yarns comprising polyester (e.g., polyethylene terephthalate), polyamide (e.g., hexamethylene adipamide, polycaprolactam), polypropylene, acrylic, cellulose acetate, polyvinylidene chloride-vinyl chloride copolymers, vinyl chloride-acrylonitrile copolymers, graphite, polyimide, silk, cotton, linen, jute, hemp, or rayon. Useful fibers may be of virgin materials or of recycled or waste materials reclaimed from garment cuttings, carpet manufacturing, fiber manufacturing, or textile processing, for example. Useful fibers may be homogenous or a composite such as a bicomponent fiber (e.g., a co-spun sheath-core fiber). The fibers may be tensilized and crimped, but may also be continuous filaments such as those formed by an extrusion process.

The thickness of the fabric backing generally ranges from about 0.02 to about 5 millimeters, desirably from about 0.05 to about 2.5 millimeters, and more desirably from about 0.1 to about 0.4 millimeter, although thicknesses outside of these ranges may also be useful, for example, depending on the intended use. Generally, the strength of the backing should be sufficient to resist tearing or other damage during abrading processes. The thickness and smoothness of the backing should also be suitable to provide the desired thickness and smoothness of the coated abrasive article; for example, depending on the intended application or use of the coated abrasive article.

The fabric backing may have any basis weight; typically, in a range of from 100 to 400 grams per square meter (gsm), more typically 200 to 320 gsm, and more typically 270 to 320 gsm. The fabric backing typically has good flexibility; however, this is not a requirement.

To promote adhesion of binder resins to the fabric backing, one or more surfaces of the backing may be modified by known methods including corona discharge, ultraviolet light exposure, electron beam exposure, flame treatment, and/or scuffing.

The presize layer is prepared by curing a corresponding presize layer precursor. The presize precursor comprises from 60 to 90 percent by weight of at least one curable epoxy resin preparable by reaction of epichlorohydrin with bisphenol A, based on the total weight of components a) through f). For example, based on the total weight of components a) through f), the presize precursor may comprise from 70 to 85, or 75 to 80 percent, by weight of epoxy resin (i.e., one or more epoxy resins) preparable by reaction of epichlorohydrin with bisphenol A. Typically, such resins have an average epoxy functionality of two, although higher and lower functionalities may also be useful.

The epoxy resin may be liquid or solid, but are typically liquid. Whether liquid or solid, the epoxy resin should generally be selected such that it can be dissolved in the presize precursor. In some instances, heating may be useful to facilitate dissolution of the epoxy resin.

Examples of bisphenol A-epichlorohydrin derived epoxy resins, bisphenol A diglycidyl ether (commonly referred to in the art as DGEBA) and commercially available bisphenol A-derived epoxy resins having the trade designation “EPON” (e.g., EPON RESIN 825, EPON RESIN 828, EPON RESIN 1001F, EPON RESIN 1002F, EPON RESIN 1004F, EPON RESIN 1007F, and EPON RESIN 1009F), marketed by Hexion Specialty Chemicals, Columbus, Ohio, and bisphenol A-derived epoxy resins having the trade designation “DER” (e.g., DER 332, DER 337, DER 362, and DER 364), marketed by Dow Chemical Company, Midland, Mich.

Based on the total weight of components a) through f), the presize layer precursor further comprises from 5 to 25 percent by weight of polyfunctional (meth)acrylate. For example, the presize layer precursor may comprise from 8 to 20 percent by weight of polyfunctional (meth)acrylate, or from 10 to 15 percent by weight of polyfunctional (meth)acrylate. The polyfunctional (meth)acrylate has an acrylate functionality of at least two, more typically at least three; for example, at least 3, 4, or even 5, and may be a mixture of more than one polyfunctional (meth)acrylate.

A wide variety of suitable polyfunctional (meth)acrylates are readily commercially available, e.g., from such vendors as Sartomer Company, Exton, Pa., and Cytec, Stamford, Conn. Exemplary polyfunctional (meth)acrylates include ethylene glycol di(meth)acrylate, hexanediol di(meth)acrylate, triethylene glycol di(meth)acrylate, trimethylolpropane triacrylate (TMPTA), glycerol tri(meth)acrylate, pentaerythritol tri(meth)acrylate, ethoxylated trimethylolpropane tri(meth)acrylate, neopentyl glycol di(meth)acrylate, pentaerythritol tetra(meth)acrylate, dipentaerythritol penta(meth)acrylate, sorbitol tri(meth)acrylate, sorbitol hexa(meth)acrylate, Bisphenol A di(meth)acrylate, ethoxylated Bisphenol A di(meth)acrylates, acrylated epoxy oligomers (e.g., Bisphenol A-based epoxy acrylate oligomers such as, for example, those marketed under the trade designations EBECRYL 3500, EBECRYL 3600, EBECRYL 3720, and EBECRYL 3700 by Cytec), aliphatic urethane acrylate oligomers (e.g., as marketed by UCB Radcure under the trade designation EBECRYL 8402), aromatic urethane acrylate oligomers, and acrylated polyesters (e.g., as marketed by Cytec under the trade designation EBECRYL 870). Additional useful polyfunctional (meth)acrylate oligomers include acrylated polyether oligomers such as a polyethylene glycol 200 diacrylate, for example, as marketed by Sartomer Company under the trade designation SR 259; and polyethylene glycol 400 diacrylate, for example, as marketed by Sartomer Company under the trade designation SR 344.

Based on the total weight of components a) through f), the presize layer precursor further comprises from 0.1 to 10 percent by weight, typically 1 to 10 percent by weight, and more typically 1 to 5 percent by weight of an acid-functional, free-radically polymerizable material having an acid number up to 300 (in mg KOH/gram of acid-functional free-radically polymerizable material). Typically, the acid number is in a range of from 10 up to 300, more typically in a range of from 200 up to 300. Exemplary materials include acid functional acrylates marketed as PHOTOMER 4173 (acid number 210), PHOTOMER 4703 (acid number 290), and PHOTOMER 4846 (acid number 10) by Cognis Corp., Cincinnati, Ohio.

Based on the total weight of components a) through f), the presize layer precursor further comprises from 5 to 15 percent by weight of dicyandiamide, more typically 7 to 13 percent, more typically 7 to 10 percent by weight. The dicyandiamide assists in curing the presize precursor. Dicyandiamide is widely available commercially, for example, as marketed by Air Products and Chemicals, Allentown, Pa., as AMICURE CG-1200 and AMICURE CG-1400.

The presize layer precursor further comprises an effective amount of photoinitiator for free-radically polymerizing, typically B-staging, the polyfunctional (meth)acrylate and the acid-functional free-radically polymerizable material having an acid number up to 300. For example, the presize layer precursor may comprise from 0.1, 1, or 3 percent by weight, up to 5, 7, or even 10 percent or more by weight of photoinitiator, based on the total weight of components a) through f). By B-staging the presize layer precursor, flow of the presize layer precursor during heat curing (e.g., as in a festoon oven) is reduced or eliminated.

The photoinitiator may be a single photoinitiator or a combination of two or more photoinitiators. Exemplary photoinitiators include benzoin and its derivatives such as alpha-methylbenzoin; alpha-phenylbenzoin; alpha-allylbenzoin; alpha-benzylbenzoin; benzoin ethers such as benzil dimethyl ketal (available, e.g., as IRGACURE 651 from Ciba Specialty Chemicals, Tarrytown, N.Y.), benzoin methyl ether, benzoin ethyl ether, benzoin n-butyl ether; acetophenone and its derivatives such as 2-hydroxy-2-methyl-1-phenyl-1-propanone (available, e.g., as DAROCUR 1173 from Ciba Specialty Chemicals) and 1-hydroxycyclohexyl phenyl ketone (available, e.g., as IRGACURE 184 from Ciba Specialty Chemicals); 2-methyl-1-[4-(methylthio)phenyl]-2-(4-morpholinyl)-1-propanone (available, e.g., as IRGACURE 907 from Ciba Specialty Chemicals); 2-benzyl-2-(dimethylamino)-1-[4-(4-morpholinyl)phenyl]-1-butanone (available, e.g., as IRGACURE 369 from Ciba Specialty Chemicals).

Useful photoinitiators also include pivaloin ethyl ether, anisoin ethyl ether; anthraquinones, such as anthraquinone, 2-ethylanthraquinone, 1-chloroanthraquinone, 1,4-dimethylanthraquinone, 1-methoxyanthraquinone, benzanthraquinonehalomethyltriazines, and the like; benzophenone and its derivatives; iodonium salts and sulfonium salts as described hereinabove; titanium complexes such as bis(eta₅-2,4-cyclopentadien-1-yl)bis[2,6-difluoro-3-(1H-pyrrol-1-yl)phenyl]titanium (available, e.g., as CGI 784 DC from Ciba Specialty Chemicals); halomethylnitrobenzenes such as 4-bromomethyl-nitrobenzene and the like; mono- and bis-acylphosphines (available, e.g., from Ciba Specialty Chemicals as IRGACURE 1700, IRGACURE 1800, IRGACURE 1850, and DAROCUR 4265).

Based on the total weight of components a) through f), the presize layer precursor optionally further comprises an effective amount of epoxy cure catalyst. Epoxy cure catalysts are well known and include imidazoles such as, for example, 2-ethylimidazole, and 2-ethyl-4-methylimidazole (e.g., as marketed as IMICURE EMI-2,4 by Air Products and Chemicals, Allentown, Pa., and 2-propylimidazole (e.g., as marketed under the trade designation ACTIRON NXJ-60 by Synthron, Morganton, N.C.); and Lewis acid complexes such as boron trifluoride and boron trichloride complexes including, for example, BF₃/diethylamine and a BCl₃/amine complex marketed as OMICURE BC-120 by CVC Specialty Chemicals, Maple Shade, N.J. Other useful epoxy cure catalysts include aliphatic and aromatic tertiary amines including, for example, dimethylpropylamine, pyridine, dimethylaminopyridine, and dimethylbenzylamine. If included, the amount of epoxy cure catalyst typically is typically in an amount of from 0.1 to 2 percent by weight, based on the total weight of components a) through f), although higher and lower amounts may also be useful.

The presize layer precursor may further contain a variety of additives such as, for example, fillers, thickeners, tougheners, pigments, fibers, tackifiers, lubricants, wetting agents, surfactants, antifoaming agents, dyes, coupling agents, plasticizers, and suspending agents.

Materials useful as the optional backsize layer include, for example, phenolic resins (especially, resole resins), epoxy resins, acrylate resins, acrylic latexes, urethane resins, aminoplasts, glue, starch, and combinations thereof. The optional backsize layer may contain additional additives such as, for example, a filler and/or an antistatic material (e.g., carbon black particles, vanadium pentoxide particles). The addition of an antistatic material can reduce the tendency of the coated abrasive article to accumulate static electricity when sanding wood or wood-like materials. Additional details concerning backsize layers may be found in, for example, U.S. Pat. Appl. Publ. Nos. 2005/0100739 A1 (Thurber et al); 2004/0002951 A1 (Kincaid et al.); and 2005/0282029 A1, (Keipert et al.); and U.S. Pat. No. 5,108,463 (Buchanan et al.); U.S. Pat. No. 5,137,542 (Buchanan et al.); U.S. Pat. No. 5,328,716 (Buchanan); U.S. Pat. No. 5,560,753 (Buchanan et al.); U.S. Pat. No. 6,372,336 B1 (Clausen et al.); U.S. Pat. No. 6,936,083 B2 (Thurber et al.); U.S. Pat. No. 7,344,574 B2 (Thurber et al.); and U.S. Pat. No. 7,344,575 B2 (Thurber et al.).

The presize layer precursor is typically capable of being B-staged by actinic radiation. This has significant advantage, because, once B-staged, the presize layer precursor will not substantially flow during subsequent thermal curing. This substantial elimination of flow permits single pass coating and curing while achieving a sealed fabric backing, while current industry processes using phenolic resins typically require two or more coating passes to achieve a properly sealed backing.

The presize is cured by exposure to actinic radiation, followed by exposure to thermal energy (which may not occur until after applying the make coat precursor or later).

The choice of the source of actinic radiation is typically selected depending on the intended processing conditions, and to appropriately activate the photoinitiator. Exemplary useful sources of ultraviolet and visible radiation include mercury, xenon, carbon arc, tungsten filament lamps, and sunlight. Ultraviolet radiation, especially from a medium pressure mercury arc lamp or a microwave driven H-type, D-type, or V-type mercury lamp, such as of those commercially available from Fusion UV Systems, Gaithersburg, Md., is especially desirable. Exposure times for the actinic radiation typically range, for example, from up to about 0.01 second to 1 minute or longer providing, for example, a total energy exposure from 0.1 to 10 Joules per square centimeter (J/cm²) depending upon the amount and the type of reactive components involved, the energy source, web speed, the distance from the energy source, and the thickness of the make layer to be cured. Filters and/or dichroic reflectors may also be useful, for example, to reduce thermal energy that accompanies the actinic radiation.

Useful forms of thermal energy include, for example, heat and infrared radiation. Exemplary sources of thermal energy include ovens (e.g., festoon ovens), heated rolls, hot air blowers, infrared lamps, and combinations thereof.

The make layer can be formed by coating a curable make layer precursor onto a major surface of the backing. The make layer precursor may comprise, for example, glue, phenolic resin, aminoplast resin, urea-formaldehyde resin, urethane resin, free-radically polymerizable polyfunctional (meth)acrylate (e.g., aminoplast resin having pendant alpha,beta-unsaturated groups, acrylated urethane, acrylated epoxy, acrylated isocyanurate), epoxy resin (including bis-maleimide and fluorene-modified epoxy resins), isocyanurate resin, and combinations thereof.

The basis weight of the make layer utilized may depend, for example, on the intended use(s), type(s) of abrasive particles, and nature of the coated abrasive article being prepared, but generally will be in the range of from 1, 2, 5, 10, or 15 gsm to 20, 25, 100, 200, 300, 400, or even 600 gsm. The make layer may be applied by any known coating method for applying a make layer (e.g., a make coat) to a backing, including, for example, roll coating, extrusion die coating, curtain coating, knife coating, gravure coating, and spray coating.

Once the make layer precursor is coated on the backing, abrasive particles are applied to and embedded in the make layer precursor (e.g., by drop coating and/or electrostatic coating). The abrasive particles can be applied or placed randomly or in a precise pattern onto the make layer precursor.

Exemplary useful abrasive particles include fused aluminum oxide based materials such as aluminum oxide, ceramic aluminum oxide (which may include one or more metal oxide modifiers and/or seeding or nucleating agents), and heat-treated aluminum oxide, silicon carbide, co-fused alumina-zirconia, diamond, ceria, titanium diboride, cubic boron nitride, boron carbide, garnet, flint, emery, sol-gel derived abrasive particles, and blends thereof. Examples of ceramic abrasive particles include those described in U.S. Pat. No. 4,314,827 (Leitheiser et al.); U.S. Pat. No. 4,518,397 (Leitheiser et al.); U.S. Pat. No. 4,623,364 (Cottringer et al.); U.S. Pat. No. 4,744,802 (Schwabel); U.S. Pat. No. 4,770,671 (Monroe et al.); U.S. Pat. No. 4,881,951 (Wood et al.); U.S. Pat. No. 5,011,508 (Wald et al.); U.S. Pat. No. 5,090,968 (Pellow); U.S. Pat. No. 5,139,978 (Wood); U.S. Pat. No. 5,201,916 (Berg et al.); U.S. Pat. No. 5,227,104 (Bauer); U.S. Pat. No. 5,366,523 (Rowenhorst et al.); U.S. Pat. No. 5,429,647 (Larmie); U.S. Pat. No. 5,498,269 (Larmie); and U.S. Pat. No. 5,551,963 (Larmie). The abrasive particles may be in the form of, for example, individual particles, agglomerates, abrasive composite particles, and mixtures thereof.

Exemplary agglomerates are described, for example, in U.S. Pat. No. 4,652,275 (Bloecher et al.) and U.S. Pat. No. 4,799,939 (Bloecher et al.). It is also within the scope of the present disclosure to use diluent erodible agglomerate grains as described, for example, in U.S. Pat. No. 5,078,753 (Broberg et al.). Abrasive composite particles comprise abrasive grains in a binder.

Exemplary abrasive composite particles are described, for example, in U.S. Pat. No. 5,549,962 (Holmes et al.).

Coating weights for the abrasive particles may depend, for example, on the specific coated abrasive article desired, the process for applying the abrasive particles, and the size of the abrasive particles, but typically range from 1 to 2000 gsm.

The abrasive particles typically have a size in a range of from 0.1 to about 5000 micrometers, more typically from about 1 to about 2000 micrometers; more typically from about 5 to about 1500 micrometers, more typically from about 100 to about 1500 micrometers, although other sizes may be used.

The abrasive particles are typically selected to correspond to abrasives industry accepted nominal grades such as, for example, the American National Standards Institute, Inc. (ANSI) standards, Federation of European Producers of Abrasive Products (FEPA) standards, and Japanese Industrial Standard (JIS) standards. Exemplary ANSI grade designations (i.e., specified nominal grades) include: ANSI 4, ANSI 6, ANSI 8, ANSI 16, ANSI 24, ANSI 36, ANSI 40, ANSI 50, ANSI 60, ANSI 80, ANSI 100, ANSI 120, ANSI 150, ANSI 180, ANSI 220, ANSI 240, ANSI 280, ANSI 320, ANSI 360, ANSI 400, and ANSI 600. Exemplary FEPA grade designations include: P8, P12, P16, P24, P36, P40, P50, P60, P80, P100, P120, P180, P220, P320, P400, P500, 600, P800, P1000, and P1200. Exemplary JIS grade designations include: JIS8, JIS12, JIS16, JIS24, JIS36, JIS46, JIS54, JIS60, JIS80, JIS100, JIS150, JIS180, JIS220, JIS240, JIS280, JIS320, JIS360, JIS400, JIS400, JIS600, JIS800, JIS1000, JIS1500, JIS2500, JIS4000, JIS6000, JIS8000, and JIS10,000.

Once the abrasive particles have been embedded in the make layer precursor, it is at least partially cured in order to preserve orientation of the mineral, e.g., during application of the optional size layer precursor. Typically, this involves B-staging the make layer precursor, but more advanced cures may also be used if desired. B-staging may be accomplished, for example, using heat and/or light and/or use of a curative, depending on the nature of the make layer precursor selected.

Optionally, a size layer precursor may be applied over the at least partially cured make layer precursor and abrasive particles. The size layer precursor may comprise, for example, glue, phenolic resin, aminoplast resin, urea-formaldehyde resin, urethane resin, free-radically polymerizable polyfunctional (meth)acrylate (e.g., aminoplast resin having pendant alpha,beta-unsaturated groups, acrylated urethane, acrylated epoxy, acrylated isocyanurate), epoxy resin (including bis-maleimide and fluorene-modified epoxy resins), isocyanurate resin, and mixtures thereof. The size layer precursor may be applied by any known coating method for applying a size layer to a backing, including, e.g., roll coating, extrusion die coating, curtain coating, knife coating, gravure coating, and spray coating. The basis weight of the size layer will also necessarily vary depending on the intended use(s), type(s) of abrasive particles, and nature of the coated abrasive article being prepared, but generally will be in the range of from 1 or 5 gsm to 300, 400, or even 500 gsm, or more.

Once applied, the size layer precursor, and optionally, the at least partially cured make layer precursor, are sufficiently cured to provide a usable coated abrasive article. In general, this curing step involves thermal energy, but this is not a requirement. Useful forms of thermal energy include, for example, heat and infrared radiation. Exemplary sources of thermal energy include ovens (e.g., festoon ovens), heated rolls, hot air blowers, infrared lamps, and combinations thereof.

In addition to other components, the make and size layer precursors may contain optional additives, for example, to modify performance and/or appearance. Exemplary additives include grinding aids, fillers, plasticizers, wetting agents, surfactants, pigments, coupling agents, fibers, lubricants, thixotropic materials, antistatic agents, suspending agents, and/or dyes.

Exemplary grinding aids, which may be organic or inorganic, include: halogenated organic compounds such as chlorinated waxes like tetrachloronaphthalene, pentachloronaphthalene, and polyvinyl chloride; halide salts such as sodium chloride, potassium cryolite, sodium cryolite, ammonium cryolite, potassium tetrafluoroborate, sodium tetrafluoroborate, silicon fluorides, potassium chloride, magnesium chloride; and metals and their alloys such as tin, lead, bismuth, cobalt, antimony, cadmium, iron, and titanium; and the like. Examples of other grinding aids include sulfur, organic sulfur compounds, graphite, and metallic sulfides. A combination of different grinding aids can be used.

Exemplary antistatic agents include electrically conductive material such as vanadium pentoxide (e.g., dispersed in a sulfonated polyester), humectants, carbon black and/or graphite in a binder.

Examples of useful fillers for this invention include silica such as quartz, glass beads, glass bubbles and glass fibers; silicates such as talc, clays, (montmorillonite) feldspar, mica, calcium silicate, calcium metasilicate, sodium aluminosilicate, sodium silicate; metal sulfates such as calcium sulfate, barium sulfate, sodium sulfate, aluminum sodium sulfate, aluminum sulfate; gypsum; vermiculite; wood flour; aluminum trihydrate; carbon black; aluminum oxide; titanium dioxide; cryolite; chiolite; and metal sulfites such as calcium sulfite.

Optionally, a supersize layer may be applied to at least a portion of the optional size layer. If present, the supersize layer typically includes grinding aids and/or anti-loading materials. The optional supersize layer may serve to prevent or reduce the accumulation of swarf (the material abraded from a workpiece) between abrasive particles, which can dramatically reduce the cutting ability of the coated abrasive article. Useful supersize layers typically include a grinding aid (e.g., potassium tetrafluoroborate), metal salts of fatty acids (e.g., zinc stearate or calcium stearate), salts of phosphate esters (e.g., potassium behenyl phosphate), phosphate esters, urea-formaldehyde resins, mineral oils, crosslinked silanes, crosslinked silicones, and/or fluorochemicals. Useful supersize materials are further described, for example, in U.S. Pat. No. 5,556,437 (Lee et al.). Typically, the amount of grinding aid incorporated into coated abrasive products is about 50 to about 400 gsm, more typically about 80 to about 300 gsm. The supersize may contain a binder such as for example, those used to prepare the size or make layer, but it need not have any binder.

In some instances, it may be desirable to secure an optional attachment interface onto the optional backsize layer or side of the coated abrasive article opposite the abrasive layer such that the resulting coated abrasive article can be secured to a back up pad.

The abrasive attachment interface of the abrasive article mounting assembly of the present disclosure can consist of a non-continuous layer of adhesive, a sheet material, or a combination thereof. The sheet material can comprise, for example, a loop portion or a hook portion of a two-part mechanical engagement system. In other embodiment, the abrasive attachment interface comprises a layer of pressure sensitive adhesive with an optional release liner to protect it during handling.

In some embodiments, the abrasive attachment interface of the abrasive article mounting assembly of the present disclosure comprises a nonwoven, woven or knitted loop material. Suitable materials for a loop abrasive attachment interface include both woven and nonwoven materials. Woven and knit abrasive attachment interface materials can have loop-forming filaments or yarns included in their fabric structure to form upstanding loops for engaging hooks. Nonwoven loop attachment interface materials can have loops formed by the interlocking fibers. In some nonwoven loop attachment interface materials, the loops are formed by stitching a yarn through the nonwoven web to form upstanding loops.

Coated abrasive articles according to the present disclosure can be converted, for example, into belts, tapes, rolls, discs (including perforated discs), and/or sheets. For belt applications, two free ends of the abrasive sheet may be joined together using known methods to form a spliced belt. A spliceless belt may also be formed as described, for example, in U.S. Pat. No. 5,573,619 (Benedict et al.).

Coated abrasive articles according to the present disclosure are useful for abrading a workpiece. One such method includes frictionally contacting at least a portion of the abrasive layer of a coated abrasive article with at least a portion of a surface of the workpiece, and moving at least one of the coated abrasive article or the workpiece relative to the other to abrade at least a portion of the surface. Examples of workpiece materials include metal, metal alloys, exotic metal alloys, ceramics, glass, wood, wood-like materials, composites, painted surfaces, plastics, reinforced plastics, stone, and/or combinations thereof. The workpiece may be flat or have a shape or contour associated with it. Exemplary workpieces include metal components, plastic components, particleboard, camshafts, crankshafts, furniture, and turbine blades.

Coated abrasive articles according to the present disclosure may be used by hand and/or used in combination with a machine. At least one or both of the coated abrasive article and the workpiece is generally moved relative to the other when abrading. Abrading may be conducted under wet or dry conditions. Exemplary liquids for wet abrading include water, water containing conventional rust inhibiting compounds, lubricant, oil, soap, and cutting fluid. The liquid may also contain defoamers, degreasers, and/or the like.

Objects and advantages of this invention are further illustrated by the following non-limiting examples, but the particular materials and amounts thereof recited in these examples, as well as other conditions and, details, should not be construed to unduly limit this invention.

### EXAMPLES

Unless otherwise noted, all parts, percentages, ratios, etc. in the Examples and the rest of the specification are by weight. The following abbreviations are used throughout the examples that follow.

TABLE OF ABBREVIATIONS

| ABBREVIATION | DESCRIPTION |
|---|---|
| EP1 | Epoxy resin, bisphenol A/epichlorohydrin derived |
| | epoxy functional material, available as EPON 828 |
| | from Hexion Specialty Chemicals, Columbus, OH |
| PI1 | Photoinitiator, 2,2-dimethoxy-2- |
| | phenylacetophenone, available as IRGACURE 651 |
| | from Ciba Specialty Chemicals, Tarrytown, NY |
| PFA1 | Polyfunctional acrylate, trimethylolpropane |
| | triacrylate, available as TMPTA-N from UCB |
| | Radcure Chemical Corp., Smyrna, GA |
| PA1 | acid-functional free-radically polymerizable |
| | material, acid functional acrylate (acid number 210), |
| | available as PHOTOMER 4173 from Cognis Corp., |
| | Cincinnati, OH |
| DICY | Dicyandiamide, available as AMICURE CG 1400 |
| | from Air Products and Chemicals, Allentown, PA |
| CUR1 | Curative, 2-propylimidazole, obtained as ACTIRON |
| | NXJ-60 LIQUID from Synthron, Morganton, NC |

### Preparation of Presize Precursor 1 (CTR1)

A jar was charged with 75 parts of EP1 (epoxy resin preparable by reaction of epichlorohydrin with bisphenol A) and 1 part of PI1 (photoinitiator) was placed in an oven for 30 minutes at 55° C. The jar was removed and 10 parts of PFA1 (polyfunctional (meth)acrylate), 1 part of PA1 (acid-functional free-radically polymerizable material) and 8 parts of DICY (dicyandiamide) was charged to the jar and mixed. Finally, 0.75 parts of CUR1 (curative) was added to the jar and mixed just prior to coating the presize precursor.

### Preparation of Presize Precursor 2 (CTR2)

A jar was charged with 75 parts of EP1 and 1 part of PI1 was placed in an oven for 30 minutes at 55° C. The jar was removed and 10 parts of PFA1, 3 parts of PA1 and 8 parts of DICY was charged to the jar and mixed. Finally, 0.75 parts of CUR1 was added to the jar and mixed just prior to coating the presize precursor.

### Preparation of Presize Precursor 3 (CTR3)

A jar was charged with 75 parts of EP1 and 1 part of PI1 was placed in an oven for 30 minutes at 55° C. The jar was removed and 10 parts of PFA1, 5 parts of PA1 and 8 parts of DICY was charged to the jar and mixed. Finally, 0.75 parts of CUR1 was added to the jar and mixed just prior to coating the presize precursor.

### Preparation of Presize Precursor 4 (CTR4)

A jar was charged with 75 parts of EP1 and 1 part of PI1 was placed in an oven for 30 minutes at 55° C. The jar was removed and 10 parts of PFA1, 10 parts of PA1 and 8 parts of DICY was charged to the jar and mixed. Finally, 0.75 parts of CUR1 was added to the jar and mixed just prior to coating the presize precursor.

### Preparation of Comparative Presize Precursor A (CTRC1)

A jar was charged with 75 parts of EP1 and 1 part of PI1 was placed in an oven for 30 minutes at 55° C. The jar was removed and 10 parts of PFA1 and 15 parts of PA1. The mixture was not homogenous. Next, 8 parts of DICY was charged to the jar and mixed, resulting in an inhomogeneous mixture. Finally, 0.75 parts of CUR1 was added to the jar and mixed just prior to coating the comparative presize precursor.

### Preparation of Comparative Presize Precursor B (CTCR2)

A jar was charged with 75 parts of EP1 and 1 part of PI1 was placed in an oven for 30 minutes at 55° C. The jar was removed and 10 parts of PFA1 and 8 parts of DICY was charged to the jar and mixed. Finally, 0.75 parts of CUR1 was added to the jar and mixed just prior to coating the presize precursor.

### Backsize Precursor 1 (BSR1)

CaCO₃ (450 parts), 15 parts of iron oxide, and 285 parts of a phenol-formaldehyde resin having a phenol to formaldehyde ratio of 1.5-2.1/1, catalyzed with 1% to 5% by weight potassium hydroxide were mechanically stirred until homogeneous at 20° C., then the mixture was then diluted to 1000 parts with water.

### Make Resin Precursor 1 (MR1)

CaCO₃ (442 parts) and 285 parts of a phenol-formaldehyde resin having a phenol to formaldehyde ratio of 1.5-2.1/1, catalyzed with 1% to 5% by weight potassium hydroxide were mechanically stirred until homogeneous at 20° C., then the mixture was then diluted to 1000 parts with water.

### Preparation of Treated Fabric Backings

A 10.2 cm wide coating knife obtained from Gardco, Pompano Beach, Fla., was prepared for use. The knife was set to a minimum gap of 76 micrometers to permit 15.2 cm wide cloth backing to pass under the knife. Untreated polyester woven cloth having a weight of 300-400 grams per square meter (gsm) was obtained from Milliken & Company, Spartanburg, S.C. The polyester cloth was placed under the coating knife set at 76 micrometers and then the presize compositions were applied to the polyester cloth by pulling the polyester cloth by hand under the knife to form a presize coat on the polyester cloth. The resultant presize precursor was B-staged by irradiation with an ultraviolet (UV) lamp (118 Watts/cm, D bulb, obtained from Fusion UV Systems, Gaithersburg, Md.), at a line speed of about 5 meters per minute. The B-staged precursor presize layer was then heated in a 160° C. oven for 10 minutes. The resultant presize weight was about 127.5 gsm. The resultant presize treated fabric backing was treated with a backsize precursor BSR1 composition using the same knife coating method. The resultant backsize weight was about 111.5 gsm. The backsize precursor was cured by placing the treated cloth backing in an oven at 90° C. for 10 minutes and at 105° C. for 15 minutes.

TABLE 1

| TREATED | | |
|---|---|---|
| FABRIC | BACKSIZE | PRESIZE |
| BACKING | PRECURSOR | PRECURSOR |
| Comparative | BSR1 | CCTR1 |
| Treated Backing A | | |
| Comparative | BSR1 | CCTR2 |
| Treated Backing B | | |

| | |
|---|---|
| Comparative | prepared according the |
| Treated Backing C | procedure of U.S. Pat. No. |
| | 6,843,815 B1 (Thurber et al.), at |
| | column 15, lines 46 to 61. |

| | | |
|---|---|---|
| Treated Backing 1 | BSR1 | CTR1 |
| Treated Backing 2 | BSR1 | CTR2 |
| Treated Backing 3 | BSR1 | CTR3 |
| Treated Backing 4 | BSR1 | CTR4 |

### Comparative Examples A-C and Examples 1 to 4

The treated backings in Table 1 (i.e., Comparative Treated Backings A to C and Treated Backings 1 to 4) were independently coated with Make Resin Precursor 1 onto the presize layer coated side of the treated backing using the knife coating procedure in the Preparation of Treated Backings described above. Next, grade 36 aluminum oxide mineral (commercially available under the trade designation ALODUR from Treibacher GmbH, Treibach, Germany) was drop coated into the make layer precursor to form a closed coat. The abrasive-coated material was cured at 90° C. for 60 minutes and 105° C. for 10 hours resulting in coated abrasives respectively denoted as Comparative Examples A-C and Examples 1 to 4.

### Stripback Adhesion Test

Coated abrasive articles to be tested were converted into an 8 centimeters (cm) wide by 25 cm long piece. One-half the length of a wooden board (17.8 cm by 7.6 cm×0.6 cm thick) was coated with a polyamide hot melt adhesive (available as JET MELT ADHESIVE PG3779 from 3M Company, St. Paul, Minn. The entire width, but only the first 15 cm of the length, of the coated abrasive article was coated with a polyamide hot melt adhesive (available as JET MELT ADHESIVE PG3779 from 3M Company on the side bearing the abrasive particles. The side of the coated abrasive article bearing the abrasive particles was attached to the side of the board containing the laminating adhesive in such a manner that the 10 cm of the abrasive article not bearing the laminating adhesive overhung for the board. Pressure was applied such that the board and the abrasive article were intimately bonded. The resulting bonded laminate was cooled to room temperature for at least 1 hour before testing. Next, the bonded laminate was cut along a straight line on both sides of the article such that the width of the bonded laminate was reduced to 5.1 cm. The resulting trimmed bonded laminate was mounted horizontally in a fixture attached to the upper jaw of a tensile force testing machine obtained under the trade designation SINTECH 6W from MTS Systems Corp., Eden Prairie, Minn., and approximately one centimeter of the overhanging portion of the coated abrasive article was mounted into the lower jaw of the machine such that the distance between the jaw was 12.7 cm. The machine separated the jaws at a rate of 0.05 cm/second, with the abrasive article being pulled at an angle of 90-degrees away from the wooden board so that a portion of the abrasive article separated from the board. Separation occurred between layers of the abrasive article (i.e., the make layer and the treated backing). The force required for separation was measured by the machine. The higher the required force, the better the adhesion of the make coat to the presize coat to the backing. Results are reported in Table 2 (below).

TABLE 2

| | | STRIPBACK |
|---|---|---|
| | | ADHESION TEST, |
| COATED | | pounds/inch |
| ABRASIVE | TREATED BACKING | (N/cm) |
| Comparative | Comparative Treated | 25.8 (45.2), |
| Example A | Backing 1 | 27.0 (47.3) |
| Comparative | Comparative Treated | 32.4 (56.7), |
| Example B | Backing 2 | 34.0 (59.5) |
| Comparative | Comparative Treated | 29.5 (51.7), |
| Example C | Backing 3 | 31.3 (54.8) |
| Example 1 | Treated Backing 1 | 33.8 (59.2), |
| | | 35.6 (62.3) |
| Example 2 | Treated Backing 2 | 33.7 (59.0), |
| | | 35.8 (62.7) |
| Example 3 | Treated Backing 3 | 33.2 (58.1), |
| | | 31.7 (55.5) |
| Example 4 | Treated Backing 4 | 29.2 (51.1), |
| | | 31.0 (54.3) |

It will be appreciated that while the foregoing coated abrasives do not have a size layer, the size layer is unnecessary in order to measure make layer-presize layer treated backing adhesion. For example, the size layer is unnecessary since the size coat does not contact the presize layer. In actual practice of a coated abrasive article according to the present disclosure, a size layer would overlay the make layer and abrasive particles.

In general, adhesive values of 29 pounds per inch (51 N/cm) in the stripback adhesion test are indicative of sufficient adhesion to be useful in heavy duty cloth backed coated abrasive products. For some applications, higher adhesion may be desirable.

All patents and publications referred to herein are hereby incorporated by reference in their entirety. Various modifications and alterations of this invention may be made by those skilled in the art without departing from the scope and spirit of this invention, and it should be understood that this invention is not to be unduly limited to the illustrative embodiments set forth herein.

What is claimed is:

1. A coated abrasive article comprising a fabric backing having a presize layer thereon, and an abrasive layer secured to and contacting the presize layer; wherein the abrasive layer comprises a make layer and abrasive particles; and wherein the presize layer comprises, based on a total weight of components a) through f), a reaction product of components comprising:
a) from 60 to 90 percent by weight of epoxy resin preparable by reaction of epichlorohydrin with bisphenol A;
b) from 5 to 25 percent by weight of polyfunctional (meth)acrylate;
c) from 0.1 to 10 percent by weight of aromatic acid-functional free-radically polymerizable material having an acid number up to 300;
d) from 5 to 15 percent by weight of dicyandiamide;
e) an effective amount of photoinitiator; and
f) optionally, an effective amount of epoxy cure catalyst.

2. The coated abrasive article of claim 1, further comprising a size layer overlaying the make layer and abrasive particles.

3. The coated abrasive article of claim 1, wherein the components comprise:
a) from 60 to 80 percent by weight of epoxy resin preparable by reaction of epichlorohydrin with bisphenol A;
b) from 5 to 15 percent by weight of polyfunctional (meth)acrylate;
c) from 1 to 5 percent by weight of aromatic acid-functional free-radically polymerizable material having an acid number up to 300;
d) from 5 to 10 percent by weight of dicyandiamide;
e) an effective amount of photoinitiator; and
f) optionally, an effective amount of epoxy cure catalyst.

4. The coated abrasive article of claim 1, wherein the components comprise:
a) from 75 to 80 percent by weight of epoxy resin preparable by reaction of epichlorohydrin with bisphenol A;
b) from 10 to 15 percent by weight of polyfunctional (meth)acrylate;
c) from 1 to 4 percent by weight of acid-functional free-radically polymerizable material having an acid number up to 300;
d) from 5 to 10 percent by weight of dicyandiamide;
e) an effective amount of photoinitiator; and
f) optionally, an effective amount of epoxy cure catalyst.

5. The coated abrasive article of claim 1, wherein the make layer comprises a phenolic resin.

6. A method of abrading a workpiece comprising:
providing a coated abrasive article according to claim 1;
frictionally contacting the abrasive layer with surface of the workpiece; and
moving at least one of the coated abrasive article and the workpiece relative to the other to abrade at least a portion of the surface.

7. A method of making an abrasive article comprising:
applying a presize layer precursor to a fabric backing, wherein based on a total weight of components a) through f), the presize layer precursor comprises components:
a) from 60 to 90 percent by weight of epoxy resin preparable by reaction of epichlorohydrin with bisphenol A;
b) from 5 to 25 percent by weight of polyfunctional (meth)acrylate;
c) from 0.1 to 10 percent by weight of acid-functional free-radically polymerizable material having an acid number up to 300;
d) from 5 to 15 percent by weight of dicyandiamide;
e) an effective amount of photoinitiator; and
f) optionally, an effective amount of epoxy cure catalyst;
at least partially curing the presize layer precursor to provide a presize layer secured to the fabric backing, wherein the presize layer substantially seals the fabric backing; and
disposing a make layer precursor on the presize layer;
embedding abrasive particles in the make layer precursor; and
at least partially curing the make layer precursor.

8. The method of claim 7, wherein at least partially curing the presize layer precursor comprises B-staging the presize layer precursor.

9. The method of claim 7, further comprising:
disposing a size layer precursor on the at least partially cured make layer precursor and abrasive particles; and
at least partially curing the size layer precursor.

10. The method of claim 7, wherein the components comprise:
a) from 60 to 80 percent by weight of epoxy resin preparable by reaction of epichlorohydrin with bisphenol A;
b) from 5 to 15 percent by weight of polyfunctional (meth)acrylate;
c) from 1 to 5 percent by weight of acid-functional free-radically polymerizable material having an acid number up to 300;
d) from 5 to 10 percent by weight of dicyandiamide;
e) an effective amount of photoinitiator; and
f) optionally, an effective amount of epoxy cure catalyst.

11. The method of claim 7, wherein the components comprise:
a) from 75 to 80 percent by weight of epoxy resin preparable by reaction of epichlorohydrin with bisphenol A;
b) from 10 to 15 percent by weight of polyfunctional (meth)acrylate;
c) from 1 to 4 percent by weight of acid-functional free-radically polymerizable material having an acid number up to 300;
d) from 5 to 10 percent by weight of dicyandiamide;
e) an effective amount of photoinitiator; and
f) optionally, an effective amount of epoxy cure catalyst.
